(19) United States
(12) Patent Application Publication
(10) Pub. No.: US 2026/0192445 A1
(43) Pub. Date: Jul. 9, 2026

(54) ROBOTIC APPARATUS TRAINING

(71) Applicant: DailyRobotics LTD., Haifa (IL)

(72) Inventors: Waseem Ghrayeb, Haifa (IL); Adham Ghazali, Haifa (IL); Saeed Esmail, Haifa (IL)

(21) Appl. No.: 19/012,382

(22) Filed: Jan. 7, 2025

(51) Int. Cl. B25J 9/16; B25J 13/08

(52) U.S. Cl. CPC B25J 9/163; B25J 9/1679; B25J 9/1697; B25J 9/1669; B25J 9/1682; B25J 13/089; G05B 19/41815

(57) ABSTRACT

A method performed in a computerized environment utilizes first and second robotic apparatuses. The method includes repeatedly utilizing the first robotic apparatus to deploy an object within a space in a position, computing, based on at least a relative location of the object to the first robotic apparatus and a physical property of the first robotic apparatus, a location of the object within the space, performing, by the second robotic apparatus, a predefined action with respect to the object, where the performing includes determining a set of instructions to the second robotic apparatus based on the computed location of the object within the space, and collecting sensor data generated using at least one sensor during the predefined action, and training a machine learning predictive model using the collected sensor data and corresponding sets of instructions. The machine learning predictive model is trained to predict instructions based on sensor data.

### TECHNICAL FIELD

The present disclosure relates to autonomous robot technologies in general, and to a system and method of training a robotic apparatus, for autonomously carrying out a physical task.

### BACKGROUND

A robotic arm is a type of a robotic apparatus that includes a mechanical arm that functions similarly to a human arm, hand and/or fingers, a computer that controls the mechanical arm for carrying out physical tasks, and other parts, as known in the art.

Some robotic apparatuses may be employed in physical tasks traditionally carried out by human workers. For example, a robotic arm may be employed for tasks that are carried out in agricultural work, say for approaching a fruit tree, gripping one of the tree's fruits, snapping the fruit, and placing the fruit in a box.

Robotic apparatuses such as the robotic arm mentioned above, may be operated by a human operator (say using a remote-control device), or rather operate autonomously without real time control by an operator.

Some robotic apparatuses are only partially autonomous, such that some of functions are carried out by the robotic apparatuses autonomously while other functions are controlled by a human operator. For example, with some robotic arms, the control may switch between autonomous and operator-controlled modes.

Autonomous or partially autonomous robotic apparatuses such as the robotic arms mentioned hereinabove, may carry out a task autonomously based on hard coded instructions (say hard coded computer instructions and/or a hard coded rules that make up a planning policy, as known in the art).

Specifically, the hard coded instructions may control the motion of the mechanical arm during performance of the task by the robotic arm. To that end, with currently available technologies, such hard coded instructions usually rely on a pre-existing mapping of the working environment (say a vehicle assembly line) that the robotic apparatus is used in.

### BRIEF SUMMARY

One exemplary embodiment of the disclosed subject matter is a method performed in a computerized environment that comprises a first robotic apparatus and a second robotic apparatus. The method comprises repeatedly performing: utilizing the first robotic apparatus to deploy an object within a space in a position; computing, based on at least a relative location of the object to the first robotic apparatus and based on a physical property of the first robotic apparatus, a location of the object within the space; performing, by the second robotic apparatus, a predefined action with respect to the object, wherein said performing comprises determining a set of instructions to the second robotic apparatus, the set of instructions being determined based on the computed location of the object within the space; and collecting sensor data generated using at least one sensor during said performing of the predefined action; and training a machine learning predictive model using the collected sensor data and corresponding sets of instructions, whereby the machine learning predictive model is trained to predict instructions based on sensor data.

Optionally, the predefined physical property comprises a property of a mechanical element used to hold the object in a predefined position with respect to the first robotic apparatus.

Optionally, wherein the predefined physical property comprises an angle degree in a joint of the first robotic apparatus.

Optionally, the first robotic apparatus comprises a robotic arm.

Optionally, the second robotic apparatus comprises a robotic arm.

Optionally, the at least one sensor comprises a camera that is mounted on the second robotic apparatus.

Optionally, the at least one sensor comprises: one or more sensors that are mounted on the second robotic apparatus; and one or more sensors that are positioned in the space.

Optionally, the at least one sensor excludes any sensor that is mounted on the first robotic apparatus.

Optionally, the predefined action comprises moving the second robotic apparatus into a position close to a position of the object.

Optionally, the predefined action comprises effecting a movement between at least two parts of the second robotic apparatus, for working on the object.

Optionally, wherein the predefined action is a picking action in which the object is picked up by the second robotic apparatus.

Optionally, the predefined action is performed based on a movement algorithm that requires knowledge of the computed location of the object within the space, wherein the machine learning model is configured to predict the instructions to perform the predefined action on a target object without having knowledge of a precise location of the target object.

Optionally, the machine learning predictive model comprises an Artificial Neural Network (ANN).

Another exemplary embodiment of the disclosed subject matter is a method comprising: collecting first sensor data; generating instructions executable by a first robotic apparatus for performing a predefined action with respect to a first object, wherein said generating is performed using the collected first sensor data and a machine learning predictive model; and controlling the first robotic apparatus using the generated instructions, whereby the first robotic apparatus performs the predefined action with respect to the first object; wherein the machine learning predictive model is trained based on a second sensor data and corresponding instructions that are gathered in a training environment, the training environment comprises a second robotic apparatus for automatically deploying one or more objects in a space and a third robotic apparatus for performing the predefined actions based on sets of instructions, wherein the sets of instructions are determined based on computed locations of the one or more objects in the space, the computed locations are computed based on relative locations of the one or more objects to the second robotic apparatus and based on physical properties of the second robotic apparatus.

Optionally, the first sensor data is gathered by a plurality of sensors that comprise: one or more sensors that are mounted on the first robotic apparatus and one or more sensors that are positioned in a stationary location and are not mounted on the first robotic apparatus.

Yet another exemplary embodiment of the disclosed subject matter is a system comprising a first robotic apparatus, a first sensor mounted on the first robotic apparatus, a second robotic apparatus, a second sensor mounted on the second robotic apparatus, a controller for controlling the first and second robotic apparatuses, wherein the controller is operatively coupled with a machine learning predictive model, wherein the machine learning predictive model is trained based on sensor data and corresponding instructions that are gathered in a training environment in which one or more objects are automatically deployed in a space and acted upon based on sets of instructions, wherein the sets of instructions are determined based on deployed locations of the one or more objects in the space; wherein said controller is configured, during a working session in a working environment, to: obtain sensor data from said first sensor; provide the sensor data to the machine learning predictive model, thereby obtaining a set of instructions for said first robotic apparatus; implementing the set of instructions on the first robotic apparatus, thereby the first robotic apparatus performing a predefined action on an object that is located in the working environment.

Optionally, said controller is further configured to: obtain a second sensor data from said second sensor; provide the second sensor data to the machine learning predictive model, thereby obtaining a second set of instructions for said second robotic apparatus; implementing the second set of instructions on the second robotic apparatus, thereby the second robotic apparatus participating in performing the predefined action on the object.

Optionally, the sets of instructions were used to perform the predefined action on the one or more objects in the training environment.

Optionally, the sensor data and corresponding instructions that are gathered in the training environment, are not gathered by said system.

### BRIEF DESCRIPTION OF THE DRAWINGS

The disclosed subject matter is herein described, by way of example only, with reference to the accompanying drawings. With specific reference now to the drawings in detail, it is stressed that the particulars shown are by way of example and for purposes of illustrative discussion of embodiments of the disclosed subject matter only, and are presented in order to provide what is believed to be the most useful and readily understood description of the principles and conceptual aspects of the disclosed subject matter. The description taken with the drawings making apparent to those skilled in the art how the several forms of the disclosed subject matter may be embodied in practice.

In the drawings:

FIG. 1 is a simplified flowchart illustrating a first exemplary method, according to an exemplary embodiment of the disclosed subject matter.

FIG. 2 is a diagram schematically illustrating a first exemplary mechanical element, according to an exemplary embodiment of the present invention.

FIG. 3 is a simplified flowchart illustrating a second exemplary method, according to an exemplary embodiment of the disclosed subject matter.

FIG. 4 is a simplified block diagram schematically illustrating a system, according to an exemplary embodiment of the disclosed subject matter.

FIG. 5 is a simplified flowchart illustrating a first exemplary implementation scenario, according to an exemplary embodiment of the disclosed subject matter.

FIG. 6 is a diagram schematically illustrating a second exemplary mechanical element, according to an exemplary embodiment of the present invention.

FIG. 7-9 are simplified flowcharts illustrating a second exemplary implementation scenario, according to an exemplary embodiment of the disclosed subject matter.

### DETAILED DESCRIPTION

The present embodiments comprise a method and a system for robotic apparatus training.

With existing technologies, autonomous or partially autonomous robotic apparatuses may carry out some physical tasks autonomously based on hard coded instructions and/or rules (say hard coded computer instructions and/or hard coded rules embedded in a planning policy, as known in the art).

Such hard coded instructions usually rely on the availability of a pre-existing mapping of a space (i.e. working environment such as a vehicle assembly line) that the robotic apparatus is used in.

However, such a pre-existing mapping is usually unavailable for an unstructured work environment such as a farm, a plantation, an agricultural field. Indeed, for example, in such a non-structured work environment, different objects such as a tree fruit or leaf, do not necessarily stay in a fixed position or orientation.

In order to generate a planning policy for an unstructured environment, there is a need to collect a vast and diverse amount of prior data derived from real world sensor measurement during performance of similar actions.

Producing such prior data may prove very expensive, and may also require high human involvement in controlling the robotic apparatus (say a robotic arm), so as to record many successful attempts to perform the similar actions.

According to an exemplary embodiment, there are rather used two or more robotic apparatuses in a series of training sessions.

In each session of the series, a first robotic apparatus (say a robotic arm) is used to deploy an object (say a fruit hanging from a tree) in a known position within a space (say within a working environment of the robotic arm) or in a position that can be calculated (say using a robot planning software, as known in the art).

In one example, in the training session, there are rather used two or more first robotic apparatuses, to hold two objects that make up a pair of objects, in respective, known or calculatable locations.

Optionally, the position is calculated based at least on a relative location of the object to the first robotic apparatus and on a physical property of the first robotic apparatus.

Then, in that training session, a second robotic apparatus (say a second robotic arm) is employed to perform a predefined physical action with respect to the deployed object.

In the training session, the second robotic apparatus performs the physical action based on a set of instructions that is determined based on the known or calculated location of the object within the space, and using instructions determined using known in the art methods or input by a human user.

Further in the session, during the performance of the action by the second robotic apparatus, there is collected sensor data (say images of the object as captured by one or more cameras of the robotic apparatus) using at least one sensor during the performance of the action.

The sensor(s) may include one or more cameras mounted on the second robotic apparatus and/or installed in the space (i.e. working environment), one or more proximity sensor installed on the second robotic apparatus and/or in the space, one or more other sensors, etc.

After the series of training sessions, a machine learning predictive model is trained using the collected sensor data and corresponding sets of determined instructions, to predict instructions for performing the action on a second object.

The sensor data that is used to train the machine learning predictive model excludes the calculated locations of the object(s) and thus does not include the coordinates of the object(s) in the space (say working environment).

As a result, the machine learning predictive model is trained to predict instructions even when the location of an object subjected to an action by a robotic apparatus controlled using the model-predicted instructions, cannot be calculated accurately.

The machine learning predictive model may be based on an Artificial Neural Network (ANN), a Support Vector Machine, a Random Forest, a Bayesian Network, Deep learning, computer vision, etc. or any combination thereof.

The second object is of a same type as the object used in the training sessions, in which training sessions the two robotic apparatuses are employed, say a fruit of a same type as the one(s) used in the training sessions.

Thus, in one example, both the object(s) used in the training sessions and the object subject to the working session are strawberries. In a second example, both the object(s) used in the training sessions and the object subject to the working session are citrus fruits. In a third examples, both the object(s) used in the training sessions and the object subject to the working session are apples (though of different cultivar).

The machine learning predictive model may thus be trained to predict the instructions for performing the action on the second object of same type, even when the exact location of the second object in the space (i.e. the working environment) is unknown, cannot be calculated, or cannot be calculated accurately.

Then, in a working session, a third robotic apparatus may be input instructions predicted by the machine learning predictive mode based on sensor data generated during the working session.

The predicted instructions control the third robotic apparatus for performing the action on the second object in the working environment of the third robotic apparatus during the working session.

The principles and operation of a system and method according to the disclosed subject matter may be better understood with reference to the drawings and accompanying description.

The disclosed subject matter is capable of other embodiments or of being practiced or carried out in various ways. Also, it is to be understood that the phraseology and terminology employed herein is for the purpose of description only and should not be regarded as limiting.

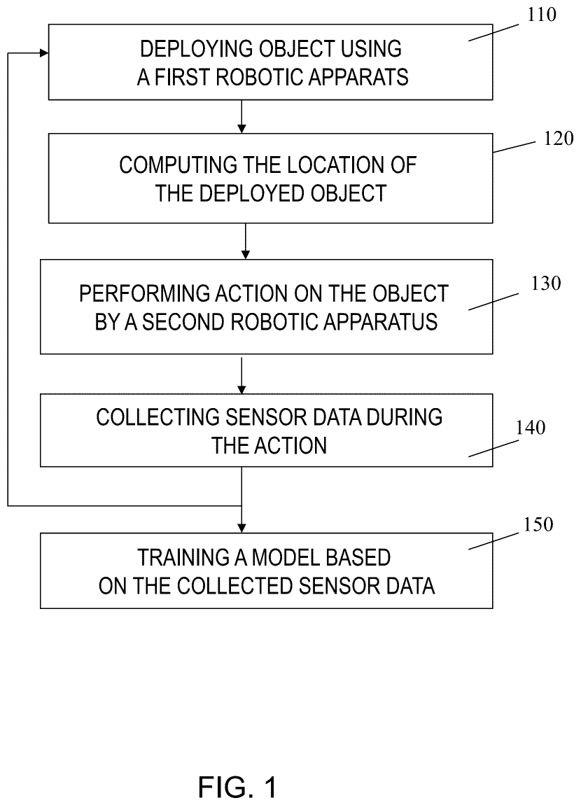

Reference is now made to FIG. 1 which is a simplified flowchart illustrating a first exemplary method, according to an exemplary embodiment of the disclosed subject matter.

The exemplary method may be used for training one or more robotic apparatuses (say an apparatus that includes a robotic arm and a computer that controls the robotic arm) for carrying out a predefined physical action, say a physical task traditionally carried out by a farmworker or another human worker.

In some cases, the physical action may be complex (i.e. an action that includes more than one physical action).

For example, the robotic apparatus (say a robotic arm) may be trained for carrying out a complex physical action that is a part of an agricultural work. In one example, the physical action includes one or more of the following: approaching a fruit hanging from a tree or a plant, gripping the fruit, snapping the fruit, and placing the fruit in a box or other container.

In the exemplary method, there are used two or more robotic apparatuses in a series of training sessions.

In each session of the series, at least one first robotic apparatus (say a robotic arm) is used to deploy an object (say a fruit hanging from a tree) in a known position within a space (say within a working environment of the robotic arm). Alternatively, the first robotic apparatus deploys the object in a position that can be calculated using known in art methods.

Then, at least one second robotic apparatus (say a second robotic arm) is employed to perform the predefined physical action with respect to the object deployed by the first robotic apparatus.

The exemplary method includes steps that at least one computer processor, say a computer processor that is a part of a circuit (i.e. hardware and associated circuitry) or of two or more circuits, is programmed to perform.

The circuit(s) form(s) a part of a computerized environment that includes one or more computer(s), a first robotic apparatus, a second robotic apparatus and possibly, additional robotic apparatuses. Optionally, the robotic apparatuses include two or more arm robots.

The computer(s) of the computerized environment are in control of the two or more robotic apparatuses, say of the robotic arms mentioned above.

In the method, there is repeatedly performed a series of steps. Each instant of performance of the series of steps is also referred to herein, as one training session.

The repeated performed series of steps include a step in which a first robotic apparatus is utilized 110 to deploy an object in a position within a space (i.e. within a working environment of the first robotic apparatus).

Then, there is computed 120 a location of the deployed object within the space, based on at least a relative location of the object to the first robotic apparatus and further based on a physical property of the first robotic apparatus.

Optionally, the physical property is defined in advance by a user or programmer of the computer(s), say by entering data that defined the property to one of the computers, using a GUI (Graphical User Interface).

In some cases, the physical property includes a property of a mechanical element of the first robotic apparatus.

Optionally, the mechanical element is used by the first robotic apparatus, to hold the object in a predefined position relative to the first robotic apparatus.

Optionally, the first robotic apparatus is a robotic arm and the physical property includes a length of one or more beams of the mechanical arm of the apparatus on/or a location of a base that the mechanical arm in mounted on. The mechanical arm is used by the robotic arm to hold the object in a position in the space (i.e. working environment).

Optionally, the physical property comprises an angle degree in a joint of the first robotic apparatus, say an angle between two beams of the mechanical arm.

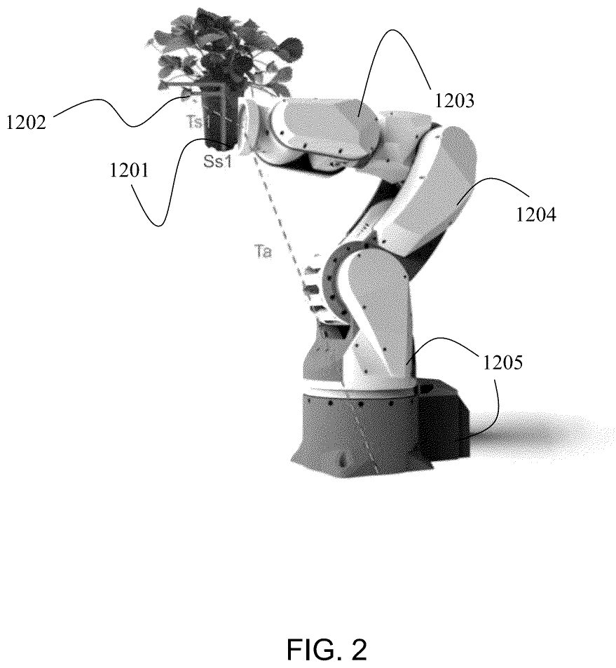

Reference is now diverted to FIG. 2 which is a diagram schematically illustrating a first exemplary mechanical element, according to an exemplary embodiment of the present invention.

In one example, there is used an exemplary mechanical element 1201 that is connected to the end of a distal beam 1203 of the mechanical arm 1203-1204 of the first robotic apparatus, at one end of the mechanical element 1201.

The mechanical element 1201 is connected to an object (say fruit) 1202 at a second end of the mechanical element 1201. The mechanical element 1201 thus holds the object 1202, such that the object's 1202 location relative to the first robotic apparatus (and more specifically, to the distal end of the mechanical arm 1203-1204) remains fixed.

In one example, the mechanical element 1201 is a straight element (say a rod). In a second example, the mechanical element 1201 is rather shaped like the capital letter gamma of the Greek Alphabet: Γ.

In any event, the mechanical element 1201 dimension(s) (say length(s)) are known in advance and may be input to the computer (say by a user or programmer of the computer), as so is the position of the mechanical element relative to the robotic apparatus.

As a result, the location of the object 1202 relative to the first robotic apparatus may be known and/or be easily calculated. As a non-limiting example, the calculations may be performed using forward kinematics, inverse kinematics, geometric triangulation, coordinate transformation, vector analysis, or the like.

The physical characteristics that make up a physical property of the robotic apparatus itself, say the characteristics of the mechanical arm 1203-1204 of the robotic apparatus, are also known in advanced and may also be input to the computer.

The physical characteristics may include, for example, the lengths of the mechanical arm's beams 1203-1204, the angle between the beams 1203-1204, the location of a base 1205 that the proximal one of the beams 1203-1204 is connected to, and the angle of inclination of the proximal beam 1204 relative to the base 1205.

As a result, the location (say coordination in the space) of the object 1202 may be computed 120 based on the relative location of the object 1202 to the first robotic apparatus and further based on a physical property of the first robotic apparatus.

Thus, for example, a transformation Ts1 that represents the location of the object 1202 that is held by mechanical element 1201 relative to the arm's end, is known or can be easily calculated. A transformation Ta that represents the location of the arm end relative to the base 1205, can be easily derived from the modeling of the mechanical arm 1203-1204 of the first robotic apparatus and so can the location of the base 1205 of the mechanical arm in the space. As a result, the location (say coordination in the space) of the object 1202 may be easily computed 120, as known in the art.

Reference is now returned to FIG. 1.

Next in the series of steps, there is performed 130 by the second robotic apparatus, a predefined action with respect to the object deployed 110 by the first robotic apparatus.

Optionally, the action is a predefined by a user or computer programmer of the second robotic apparatus, say using a GUI.

In some cases, the action is a complex physical action (i.e. an action that includes more than one physical action).

Optionally, the predefined action includes moving the second robotic apparatus into a position close to a position of the object.

Optionally, the predefined action includes effecting a movement between at least two parts of the second robotic apparatus, say between two beams of the mechanical arm or between the arm and a base that the arm is movably (say rotatably) mounts on, for working on the object.

Optionally, the predefined action is a picking action in which the object is picked up by the second robotic apparatus.

Thus, in one example, the physical action is a part of an agricultural work, say an action that includes one or more of the following: moving the second robotic apparatus into a position close to the position of the object (say a fruit hanging from a tree or a plant), gripping the object (say fruit), snapping the object, and placing the object in a box or other container.

The performing 130 of the action includes determining a set of instructions to the second robotic apparatus, based on the computed 120 location of the object within the space, using known in art methods, say using robot planner/solver tools that implements a movement algorithm, as known in the art.

Further in the series of steps, during the performance 130 of the action by the second robotic apparatus, there is collected 140 sensor data, using one or more sensor(s).

The sensor(s) may include, but are not limited to: one or more cameras mounted on the second robotic apparatus and/or in the space (i.e. working environment), one or more proximity sensor installed on the second robotic apparatus and/or in the space, sensors that measure position of one or more parts of the robotic apparatus (say a mechanical arm of the robotic apparatus or an angle between parts of the arm), one or more other sensors, etc.

Optionally, the sensor(s) include(s) one or more sensors that are installed (say mounted) on the second robotic apparatus, and one or more sensors that are positioned in the space but are not installed on the second robotic apparatus.

Optionally, the sensor(s) excludes any sensor that is mounted on the first robotic apparatus.

Further in the method, the sensor data collected 140 during the repeated series of step (i.e. the training sessions), is used together with corresponding sets of the instructions, to train 150 a machine learning predictive model to predict instructions based on sensor data.

Each one of the sets of instructions includes instructions determined when performing 130 of the action in a respective one of the training sessions, as described in further detail hereinabove.

Thus, in one exemplary scenario, after the series of training sessions, the machine learning predictive model is trained 150 using the collected 140 sensor data and corresponding sets of determined 130 instructions, to predict instructions for performing the action on a second object of a same type.

The collected 140 sensor data that is used to train 150 the machine learning predictive model excludes the computed 120 locations of the object(s) and thus does not include the coordinates of the object in the space (say working environment).

As a result, the machine learning predictive model is trained 150 to predict the instructions even when the location of an object subjected to an action by a robotic apparatus cannot be calculated accurately.

The second object is of a same type as the object used in the training sessions, in which training sessions the two robotic apparatuses are employed, say a fruit of a same type as the one(s) used in the training sessions.

Thus, in one example, both the object(s) used for the training sessions and the object subject to the working session are strawberries. In a second example, both the object(s) used for the training sessions and the object subject to the working session are citrus fruits. In a third examples, both the object(s) used for the training sessions and the object subject to the working session are apples (though of different cultivar).

The machine learning predictive model may thus potentially, be trained 150 to predict the instructions for performing the action on the second object of same type, even when the exact location of the second object in the space (i.e. the working environment) is unknown, cannot be calculated, or cannot be calculated accurately.

With previously used methods, the predefined action would have to rely on a movement algorithm that requires knowledge of the computed location of the object within the space, say an algorithm implemented by a planning software, as known in the art. However, with the exemplary method, the machine learning model is configured to predict the instructions to perform the predefined action on a target object without having knowledge of a precise location of the target object.

Thus, in a working session, a third or other robotic apparatus may be input instructions predicted by the machine learning predictive mode based on sensor data generated during the working session.

The predicted instructions may control the robotic apparatus that is input the instructions, for performing the action on the second object in a working environment of the robotic apparatus during the working session, as described in further detail hereinbelow.

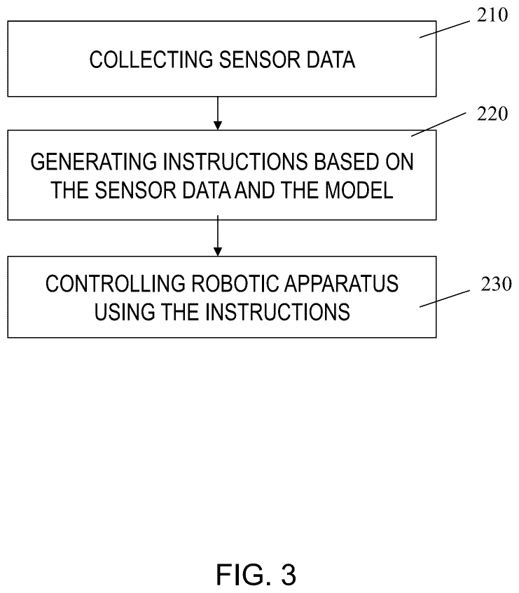

Reference is now made to FIG. 3, which is a simplified flowchart illustrating a second exemplary method, according to an exemplary embodiment of the disclosed subject matter.

FIG. 3 exemplifies a working session in which a system having two or more robotic apparatuses (e.g., robotics arms) performs physical actions on physical objects (e.g., picking up). The system includes a controller, sensors mounted on the two or more robotic apparatuses, and a trained model. Sensor data is obtained from the sensors, the trained model is utilized to provide instructions for each robotic apparatus, and the controller is utilized to implemented the instructions thereby causing the robotic apparatuses to move in accordance with the instructions. In some cases, instructions for each robotic apparatus may be based on sensors mounted thereon. Additionally, or alternatively, additional sensor data (e.g., mounted on other robotic apparatus or placed in other location in the working environment and not being mounted on any robotic apparatus) may be utilized by the trained model to determine the instructions for the respective robotic apparatus.

The method includes steps that one or more computer processor(s), say a computer processor that is a part of a circuit (i.e. hardware and associated circuitry) or computer processors that are a part of two or more circuits, is/are programmed to perform. The circuit(s) form(s) a part of a computerized environment that includes one or more computer(s) and a first robotic apparatus (say a robotic arm). The computer(s) is (are) in control of the robotic apparatus.

In the method, there is collected 210 first sensor data generated by one or more sensor(s), say images of an object as captured by one or more cameras in a working environment of the first robotic apparatus.

Optionally, the first sensor data is generated and collected 210 during performance of a predefined physical action by the first robotic apparatus, during performance a part of an agricultural task by the first robotic apparatus.

The sensor(s) may include one or more cameras mounted on the first robotic apparatus and/or in a space (say the working environment), one or more proximity sensor installed on the first robotic apparatus and/or in the space, one or more other sensors, etc., as described in further hereinabove.

Optionally, the sensors include one or more sensors that are mounted on the first robotic apparatus and one or more sensors that are positioned in a stationary location, but are not mounted on the first robotic apparatus.

Based on the collected 210 sensor data, there are generated 220 instructions that are executable by the first robotic apparatus for performing the physical action with respect to a first object.

In one example, the predefined action is a complex physical action that is a part of a task in agricultural work. For example, the physical action may include one more of the following: approaching a fruit hanging from a tree or a plant, gripping the fruit, snapping the fruit, and placing the fruit in a box or other container.

The instructions are generated 220 by a machine learning predictive model, using the collected 210 first sensor data.

Then, the first robotic apparatus is controlled 230 using the generated 220 instructions, to perform the predefined action with respect to the first object. In some cases, the robotic apparatuses may be controlled by a controller that is implemented using software, hardware, or combination thereof.

The machine learning predictive model is a model trained based on second sensor data and corresponding instructions that are gathered in a training environment during a series of training sessions, as described in further detail hereinabove.

The training environment includes a second robotic apparatus that is employed for deploying one or more objects in a space, and a third robotic apparatus that is employed for automatically performing the predefined action on the object(s) based on sets of instructions, as described in further detail hereinabove.

Optionally, during each specific one of the training sessions, a respective set of the sets of instructions is determined based on the computed location of the object deployed in the space during the training session. Optionally, the set of instructions is determined using known in art methods and/or using robot task planner/solver tools.

Optionally, the location is computed based on a relative location of the object to the second robotic apparatus and further based on one or more physical properties of the second robotic apparatus, as described in further detail hereinabove.

However, the sensor data that is used to train the machine learning predictive model excludes the calculated locations of the object(s) during the training sessions.

As a result, the machine learning predictive model is a model that is trained to predict the instructions even when the location of an object subject to an action to be carried out based on the predicted instructions, cannot be calculated or cannot be calculated accurately.

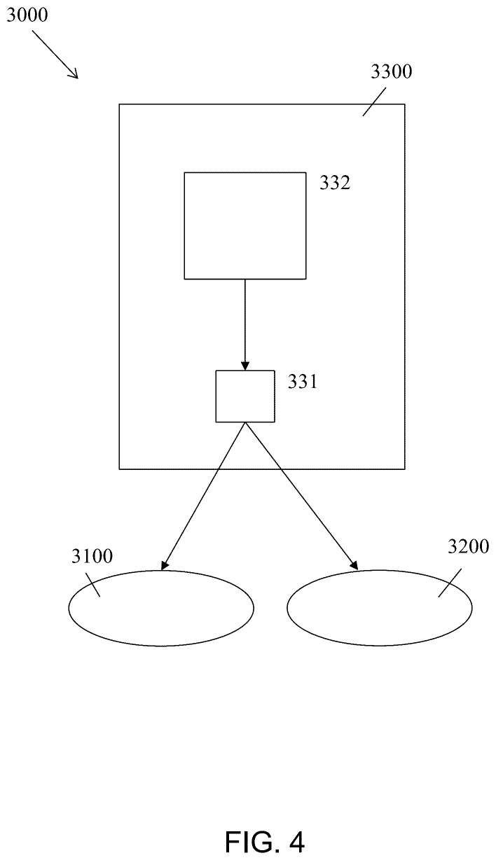

Reference is now made to FIG. 4, which is a simplified block diagram schematically illustrating a system, according to an exemplary embodiment of the disclosed subject matter.

An exemplary system 3000, according to an exemplary embodiment of the disclosed subject matter, may be implemented using electric circuits, computer software, computer hardware, or any combination thereof. The exemplary system further includes mechanical elements, say the mechanical elements (say mechanical arm) of a robotic arm or of another robotic apparatus.

The exemplary system 3000 includes a first robotic apparatus 3100 (say a first robotic arm), a second robotic apparatus 3200 (say a second robotic arm), and a circuit 3300. The circuit 3300 includes a computer processor 331 and a computer memory 332.

The computer memory 332 may include, but is not limited to: a CD-ROM, a USB-Memory, a Hard Disk Drive (HDD), a Solid-State Drive (SSD), a computer's ROM chip, an SRAM (Static Random Access Memory), a DRAM (Dynamic Random Access Memory) or other RAM (Random Access Memory) component, a cache memory component of a computer processor, a Micro SD (Secure Digital) Card, etc., or any combination thereof.

The computer memory 332 stores instructions that are executable by the computer processor 331, other parts of the circuitry, or both, for performing the steps of the exemplary method described in further detail and illustrated using FIG. 1 hereinabove.

The instructions implement a series of training sessions. In each one of the training sessions, the computer processor 331 executes a series of instructions stored on the computer memory 332. Thus, the series of instructions is repeatedly executed by the computer processor 331, as described in further detail and illustrated using FIG. 1 hereinabove.

The repeated performed series of steps include a step in which the first robotic apparatus 3100 is utilized to deploy the object in a position within a space (say within a working environment of the first robotic apparatus 3100).

Then, there is computed a location of the object within the space, based on at least a relative location of the object to the first robotic apparatus 3100 and further based on a physical property of the first robotic apparatus 3100.

In some cases, the physical property includes a property of a mechanical element of the first robotic apparatus 3100. Optionally, the mechanical element is used by the first robotic apparatus 3100, to hold the object in a predefined position with respect to the first robotic apparatus 3100.

Optionally, the first robotic apparatus 3100 is a robotic arm and the physical property includes a length of one or more beams of the mechanical arm of the first robotic apparatus 3100 and/or a location of a base that the mechanical arm is mounted on. The mechanical arm is used by the first robotic apparatus 3100 to hold the object in a location in the space.

Optionally, the physical property comprises an angle degree in a joint of the first robotic apparatus 3100, say an angle between two beams of the mechanical arm, as described in further derail hereinabove.

Optionally, the first robotic apparatus holds the object (say fruit) in a relative location that is fixed relative to the first robotic apparatus 3100.

In one example, a dedicated mechanical element (say a rod) that is connected to the object in a first end and to the robotic apparatus in a second end, holds the object (say fruit) in the relative location. As a result, the dedicated mechanical element holds the object in a fixed location relative to the distal end of the mechanical arm of the first robotic apparatus 3100 or to a base of the mechanical arm.

Accordingly, the relative location may also be known and defined (say input) in advance to the computer(s), say using a GUI or by programming, and may be a part of the predefined physical property used for computing the location of the object.

Next in the series of steps, the second robotic apparatus 3200 is used to perform a predefined action with respect to the object deployed by the first robotic apparatus 3100.

Optionally, the predefined action includes moving the second robotic apparatus 3200 into a position close to a position of the object.

Optionally, the predefined action includes effecting a movement between at least two parts of the second robotic apparatus 3200, say between two beams of the mechanical arm or between the mechanical arm and a base that the mechanical arm is movably (say rotatably) mounts on, for working on the object.

Optionally, the predefined action is a picking action in which the object is picked up by the second robotic apparatus 3200.

In one example, the physical action is a part of an agricultural work, say an action that includes one or more of the following: moving the second robotic apparatus into a position close to the position of the object (say a fruit hanging from a tree or a plant), gripping the object (say fruit), snapping the object, and placing the object in a box or other container.

The performance of the action includes determining a set of instructions for the second robotic apparatus 3200, based on the computed location of the object within the space.

The instructions are determined based on the computed 120 location of the object within the space, using known in art methods (say using robot task planning tools).

Further in the series of steps, during the performance of the action by the second robotic apparatus 3200, there is collected sensor data, using one or more sensor(s), as described in further detail hereinabove.

The executed instructions further include a step in which the sensor data collected during the repeated series of step (i.e. the training sessions), is used together with corresponding sets of the instructions, to train a machine learning predictive model to predict instructions based on sensor data.

Each one of the corresponding sets of instructions includes instructions determined when performing the action in a respective one of the training sessions.

Thus, in one example, after the series of training sessions, the machine learning predictive model is trained using the collected sensor data and corresponding sets of determined instructions, to predict instructions for performing the action on a second object.

The sensor data that used to train the machine learning predictive model excludes the calculated locations of the object(s).

As a result, the machine learning predictive model is trained to predict instructions even when the location of an object subjected to an action by a robotic apparatus cannot be calculated accurately.

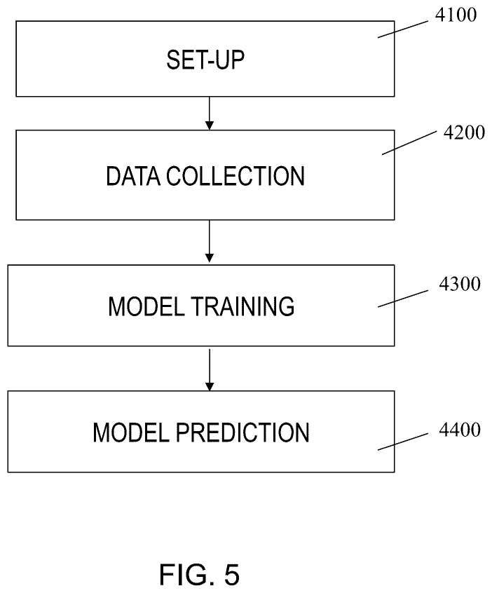

Reference is now made to FIG. 5 which is a simplified flowchart illustrating a first exemplary implementation scenario, according to an exemplary embodiment of the disclosed subject matter.

The first exemplary implementation scenario is based on an implementation of the exemplary method described in further detail and illustrated using FIG. 1 hereinabove.

The exemplary scenario includes phases of set-up 4100, data collection 4200, model training 4300, and prediction 4400.

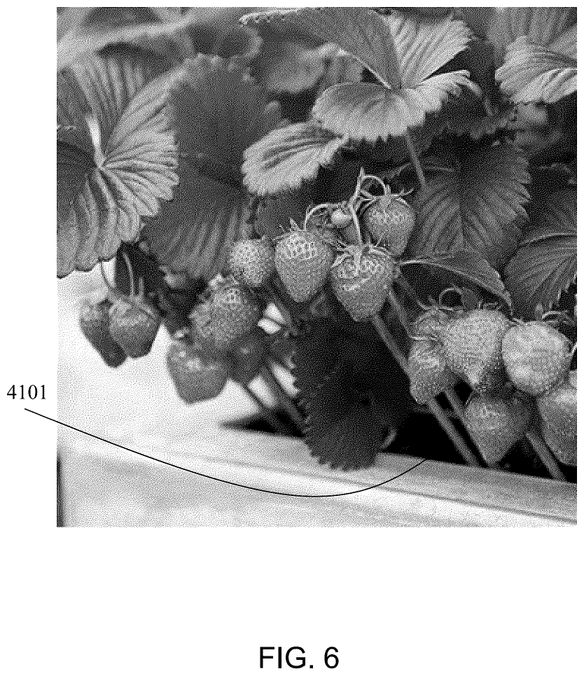

In the phase of set-up 4100, a first robotic apparatus that includes a robotic arm holds an object that is a plant with a fruit (say a strawberry). In the first scenario, the first robotic apparatus holds the fruit in a fixed location relative to the robotic apparatus. In one example, the plant is held in the fixed location relative to the robotic apparatus, using a straight mechanical element 4101 (say a rod), as illustrated in FIG. 6.

In each one of two or more training sessions, the first robotic apparatus moves the plant to a new location in a space that is a working environment of the first robotic apparatus.

In the phase of data collection 4200 that is repeated for each one of the training sessions, a second robotic apparatus that includes a robotic arm is sent to pick the object (say strawberry) from the plant and put the object in a box. To that end, the second robotic apparatus is input instructions that are generated by a planning software based on location coordinates input to the planning software, as known in the art.

The coordinates indicate the position of the object in the space. The coordinates are computed before being input to the planning software, based on at least the relative location of the object to the first robotic apparatus and on a physical property of the first robotic apparatus, as described in further detail hereinabove.

In each session, as the second robotic apparatus carries out the picking and the putting of the object, there is collected sensor data generated by sensors of the second robotic apparatus and/or other sensors installed on the space, as described in further detail hereinabove.

The sensor(s) may include but are not limited to: one or more cameras mounted on the second robotic apparatus and/or in the space (i.e. working environment), one or more proximity sensor installed on the second robotic apparatus and/or in the space, sensors that measure position of one or more parts of the second robotic apparatus (say a mechanical arm of the robotic apparatus and/or an angle between beams of the arm), one or more other sensors, etc.

In the model training 4300 phase that follows the training sessions, a machine learning model is trained with the collected sensor data. Optionally, in the training 4300 phase, the machine learning model learns the features of successful trajectories and respective instructions, and their correlation with sensor data, rather than with the exact location of the object. In some aspects, the training data may include background noise to potentially improve the robustness of learning process. The background noise may include various types of background noises. These background noises may include physical distractions such as additional objects placed in the frame during training sessions, variations in lighting conditions, or the like. Additionally, or alternatively, the training data may incorporate manipulations of the collected sensor data. For example, artificial noise may be added to the sensor data, or the model may be trained on partial sensor data by providing information from only some sensors while simulating faulty or missing data from others (e.g., replacing video feeds with black screens). By including these diverse scenarios in the training data, the machine learning predictive model may become more resilient to real-world variations and potential sensor malfunctions, potentially improving its performance in unpredictable environments.

Finally, in the phase of predicting 4400, the machine learning model is employed to predict steps in a trajectory toward the object based real-time sensors data and respective instructions. As a result, a third robotic apparatus, controlled using the predicted instructions, may be able to pick a similar object in an unstructured environment, even when the exact location of the object is not known or cannot be calculated.

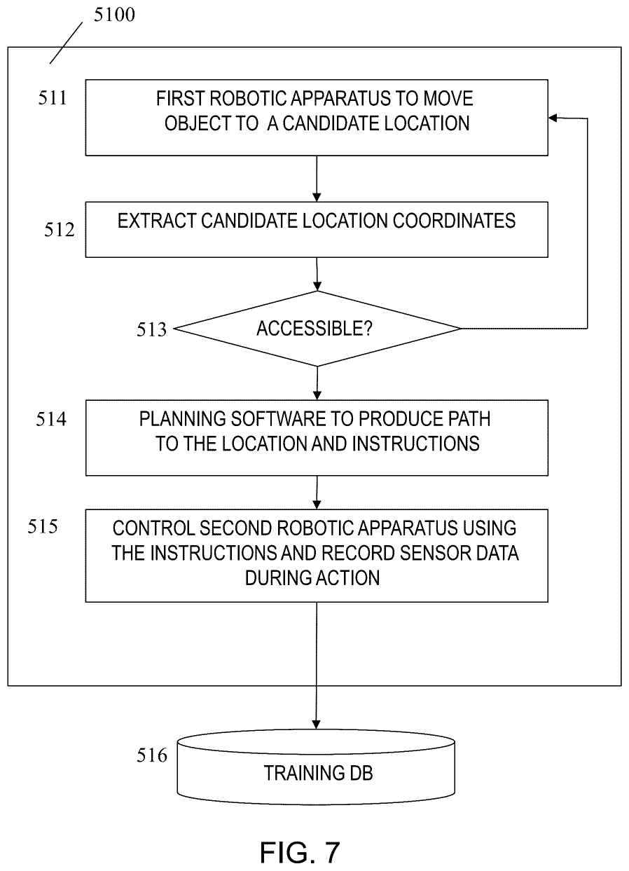

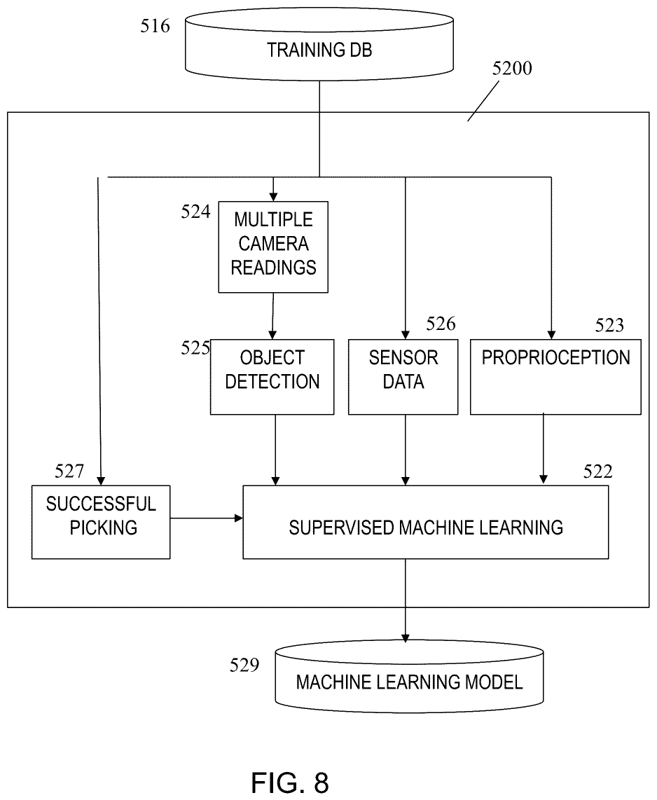

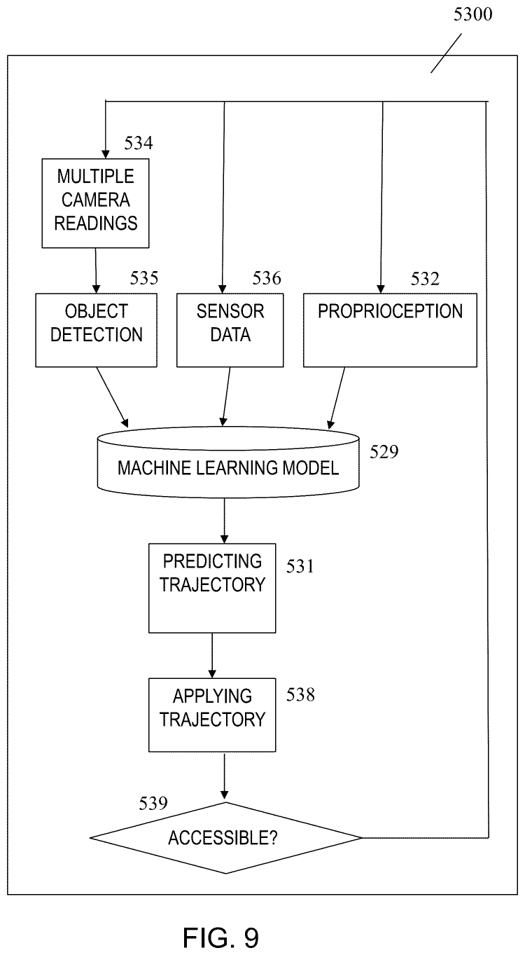

Reference is now made to FIG. 7-9 that are simplified flowcharts illustrating a second exemplary implementation scenario, according to an exemplary embodiment of the disclosed subject matter.

The second exemplary implementation scenario is based on an implementation of the exemplary method described in further detail and illustrated using FIG. 1 hereinabove.

The exemplary scenario includes a phase of data collection 5100, a phase of model training 5200, and a phase of prediction 5300.

In the phase of data collection 5100 that is carried out for each one of two or more training sessions, the first robotic apparatus (say the first robotic arm) moves 511 an object (say a fruit hanging from a plant) to a candidate location in a space that is the working environment of the first robotic apparatus.

Then, there is extracted 512 a respective set of coordinates of the candidate location in the space, and used to determined 513 if the candidate location can be accessed by a second robotic apparatus (say the second robotic arm).

If the candidate location is determined 513 to be not accessible by the second robotic apparatus, the first robotic apparatus is instructed to move the 511 the object to a new candidate location. Thus, the first robotic apparatus is instructed to move the object between candidate locations, until a candidate location (i.e. the extracted coordinates 512) of the object is determined 513 to be accessible by the second robotic apparatus.

Upon deployment 511 of the object in a location determined 513 to be accessible, a robot planner tool and/or other known in the art tool(s) is/are used to generate 514 a path to the object and respective instructions.

The generated 514 instructions control the second robotic apparatus, for performing 515 a physical action on the object, say for approaching the plant, picking the fruit from the plant, selecting a container among a number of containers deployed in the space (say according to a type or size of the fruit) and putting the fruit in the selected container.

During the performance 515 of the action on the object, there is collected 515 sensor data generated by sensors of the second robotic apparatus and/or other sensors installed on the space. The collected sensor data is stored a database 516, to base a training 5200 of a machine learning model on.

In the phase of training 5200, the machine learning model 529 is trained 521 by supervised machine learning 522 that is based on sensor data and other data retrieved from the database 516 and input 522-526 to the process of the supervised machine learning 522.

The supervised machine learning 522 is carried out based on a proprioception step 523 in which the positions of different parts of the second robotic apparatus (say the location of the mechanical arm's base, the angle between beams of the arm, etc.), is calculated.

The calculation of the positions of the parts may be based on readings by one or more sensors installed on the second robotic apparatus or the space.

Optionally, the supervised machine learning 522 is further based on image data generated 524 by one or camera(s) of the second robotic apparatus an/or other cameras installed in the working environment (i.e. space) of the first and second robotic apparatuses.

Optionally, the generated 524 image data is subjected to object detection 525, say for filtering the generated 524 image data such that only image data of relevance (say the ones in which the object appears) is input to the step of supervised machine learning 522.

Optionally, the supervised machine learning 522 is further forwarded 526 other sensor data (say from proximity sensors, infrared sensors, etc.

The supervised machine learning 522 is also forwarded 527 with data indicating if the training session that each part of the data that is input 522-526 to the supervised machine learning 522 is a successful one (say a one in which the fruit is successfully picked from the plant and put in the container).

The generated 521 machine learning model 529 may be used for controlling an autonomous performance of the action by a third robotic apparatus (say a third robotic arm) on a similar object (say an objects of a same type as the object used in the training sessions).

Thus, in a prediction phase 5300, the trained machine learning model 529 is used to predict 531 a trajectory and respective instructions for the third robotic apparatus.

The machine learning model predicts 531 the instructions based on results of a proprioception step 532 that is carried out in real time of executing the action by the third robotic apparatus. In the proprioception step 523, the positions of different parts of the third robotic apparatus are calculated based on real time readings of one or more sensors installed on the third robotic apparatus or in the space (i.e. the working environment of the third robotic apparatus), and input to the model.

The machine learning model further bases the prediction 531 on image data generated 534 in the real time of executing the action, say by one or more camera(s) of the third robotic apparatus and/or by other cameras installed in the working environment (i.e. space) of the third robotic apparatus.

Optionally, the generated 534 image data is subjected to object detection 535, say for filtering the generated 534 image data such that only image data of relevance (say the ones in which the object appears) is input to the model.

Optionally, the model is further input 536 other sensor data generated in real time of execution of the action by the third robotic apparatus.

The third robotic apparatus is controlled 538 using the instructions predicted 531 by the model 529, until the action is successfully completed 539 by third robotic apparatus.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the disclosed subject matter.

Unless otherwise defined, all technical and scientific terms used herein have the same meaning as commonly understood by one of ordinary skill in the art to which this disclosed subject matter belongs. The materials, methods, and examples provided herein are illustrative only and not intended to be limiting.

Implementation of the method and system of the disclosed subject matter involves performing or completing certain selected tasks or steps manually, automatically, or a combination thereof. Moreover, according to actual instrumentation and equipment of preferred embodiments of the method and system of the disclosed subject matter, several selected steps could be implemented by hardware or by software on any operating system of any firmware or a combination thereof.

For example, as hardware, selected steps of the disclosed subject matter could be implemented as a chip or a circuit. As software, selected steps of the disclosed subject matter could be implemented as a plurality of software instructions being executed by a computer using any suitable operating system. In any case, selected steps of the method and system of the disclosed subject matter could be described as being performed by a data processor, such as a computing platform for executing a plurality of instructions.

The disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method performed in a computerized environment that comprises a first robotic apparatus and a second robotic apparatus, the method comprising:
repeatedly performing:
utilizing the first robotic apparatus to deploy an object within a space in a position;
computing, based on at least a relative location of the object to the first robotic apparatus and based on a physical property of the first robotic apparatus, a location of the object within the space;
performing, by the second robotic apparatus, a predefined action with respect to the object, wherein said performing comprises determining a set of instructions to the second robotic apparatus, the set of instructions being determined based on the computed location of the object within the space; and
collecting sensor data generated using at least one sensor during said performing of the predefined action; and
training a machine learning predictive model using the collected sensor data and corresponding sets of instructions, whereby the machine learning predictive model is trained to predict instructions based on sensor data.

2. The method of claim 1, wherein the predefined physical property comprises a property of a mechanical element used to hold the object in a predefined position with respect to the first robotic apparatus.

3. The method of claim 1, wherein the predefined physical property comprises an angle degree in a joint of the first robotic apparatus.

4. The method of claim 1, wherein the first robotic apparatus comprises a robotic arm.

5. The method of claim 1, wherein the second robotic apparatus comprises a robotic arm.

6. The method of claim 1, wherein the at least one sensor comprises a camera that is mounted on the second robotic apparatus.

7. The method of claim 1, wherein the at least one sensor comprises:
one or more sensors that are mounted on the second robotic apparatus; and
one or more sensors that are positioned in the space.

8. The method of claim 1, wherein the at least one sensor excludes any sensor that is mounted on the first robotic apparatus.

9. The method of claim 1, wherein the predefined action comprises moving the second robotic apparatus into a position close to a position of the object.

10. The method of claim 1, wherein the predefined action comprises effecting a movement between at least two parts of the second robotic apparatus, for working on the object.

11. The method of claim 1, wherein the predefined action is a picking action in which the object is picked up by the second robotic apparatus.

12. The method of claim 1, wherein the predefined action comprises moving the second robotic apparatus into a position close to a position of the object.

13. The method of claim 1, wherein the predefined action is performed based on a movement algorithm that requires knowledge of the computed location of the object within the space, wherein the machine learning model is configured to predict the instructions to perform the predefined action on a target object without having knowledge of a precise location of the target object.

14. The method of claim 1, wherein the machine learning predictive model comprises an Artificial Neural Network (ANN).

15. A method comprising:
collecting first sensor data;
generating instructions executable by a first robotic apparatus for performing a predefined action with respect to a first object, wherein said generating is performed using the collected first sensor data and a machine learning predictive model; and
controlling the first robotic apparatus using the generated instructions, whereby the first robotic apparatus performs the predefined action with respect to the first object;
wherein the machine learning predictive model is trained based on a second sensor data and corresponding instructions that are gathered in a training environment, the training environment comprises a second robotic apparatus for automatically deploying one or more objects in a space and a third robotic apparatus for performing the predefined actions based on sets of instructions, wherein the sets of instructions are determined based on computed locations of the one or more objects in the space, the computed locations are computed based on relative locations of the one or more objects to the second robotic apparatus and based on physical properties of the second robotic apparatus.

16. The method of claim 15, wherein the first sensor data is gathered by a plurality of sensors that comprise: one or more sensors that are mounted on the first robotic apparatus and one or more sensors that are positioned in a stationary location and are not mounted on the first robotic apparatus.

17. A system comprising
a first robotic apparatus,
a first sensor mounted on the first robotic apparatus,
a second robotic apparatus,
a second sensor mounted on the second robotic apparatus,
a controller for controlling the first and second robotic apparatuses, wherein the controller is operatively coupled with a machine learning predictive model,
wherein the machine learning predictive model is trained based on sensor data and corresponding instructions that are gathered in a training environment in which one or more objects are automatically deployed in a space and acted upon based on sets of instructions, wherein the sets of instructions are determined based on deployed locations of the one or more objects in the space;
wherein said controller is configured, during a working session in a working environment, to:
obtain sensor data from said first sensor;
provide the sensor data to the machine learning predictive model, thereby obtaining a set of instructions for said first robotic apparatus;
implementing the set of instructions on the first robotic apparatus, thereby the first robotic apparatus performing a predefined action on an object that is located in the working environment.

18. The system of claim 17, wherein said controller is further configured to:
obtain a second sensor data from said second sensor;
provide the second sensor data to the machine learning predictive model, thereby obtaining a second set of instructions for said second robotic apparatus;
implementing the second set of instructions on the second robotic apparatus, thereby the second robotic apparatus participating in performing the predefined action on the object.

19. The system of claim 17, wherein the sets of instructions were used to perform the predefined action on the one or more objects in the training environment.

20. The system of claim 17, wherein the sensor data and corresponding instructions that are gathered in the training environment, are not gathered by said system.
